(19) United States
(12) Patent Application Publication
(10) Pub. No.: US 2009/0014993 A1
(43) Pub. Date: Jan. 15, 2009

(54) Weight distributed low impact vehicle system capable of remote area access

(76) Inventor: Mark Tope, Anchorage, AK (US)

Correspondence Address: Law Office of Alicia Porter, P O Box 72425, Fairbanks, AK, 99707, US

(21) Appl. No.: 12/215,103

(22) Filed: Jun. 24, 2008

Related U.S. Application Data
(60) Provisional application No. 60/929,446, filed on Jun. 25, 2007.

(51) Int. Cl. B62D 21/02; B62D 21/00

(52) U.S. Cl. 280/781; 180/233; 180/311

(57) ABSTRACT

An ecologically friendly sub frame system that is mounted onto a pre-purchased car, van, truck, emergency vehicle or heavy equipment, said system comprising a modified rectangular hollow metal frame, an outside access frame to access all parts of the vehicle, large tires, at least two independently moving axles, and coupling mechanisms to the axles that can be attached to a vehicle to be used in areas of ecological fragility, such as the tundra, desert, or beaches. The sub frame and the large tires re-distribute the weight of the vehicle across a large surface area, which minimizes the impact of the vehicle when it travels over terrain that can easily be destroyed.

### CLAIM OF PRIORITY

Inventor claims priority of the filing date from the previous provisional patent application that was filed Jun. 25, 2007 regarding this invention. Reference No. 60/929,446 with confirmation code 8723.

### FIELD OF THE INVENTION

This system relates to the field of vehicle sub frames and chassis modifications, as well as to low impact travel over ecologically fragile terrains.

### PROPOSED CLASSIFICATION

The proposed classification for this invention is Group 280/subgroup 780, or alternatively 180 subgroup 344.

### STATEMENT REGARDING JOINT INVENTORSHIP

This invention was created by a single individual. There are no other inventors.

### STATEMENT REGARDING FEDERALLY SPONSORED RESEARCH AND DEVELOPMENT

Not applicable. Invention was conceived and reduced to practice without federal assistance.

### INCORPORATION BY REFERENCE MATERIAL

Not applicable

### STATEMENT REGARDING SMALL BUSINESS ENTITY STATUS

applicant claims small business entity status.

### STATEMENT REGARDING ASSIGNMENTS

Inventor does not make any assignments at this time.

### BACKGROUND OF THE INVENTION

There is a long felt but unmet need to go to remote areas such as isolated mining camps, oil camps, or research camps that are ecologically fragile and to allow for transportation in a way that doesn't harm the environment. Current use of a truck or heavy equipment on remote and fragile ecosystems such as remote areas of Alaska that have tundra often are inaccessible for large portions of the year, due to the weight of conventional vehicles. Traveling in a pickup truck or an industrial truck tears up the tundra, leaving ruts. The ground that is exposed warms up, and the permafrost thaws, which causes thermakarst, which is a geological condition where the exposed ground warms in the sun, and thaws the tundra nearby. Whereas in normal ecological settings the ground eventually repairs itself and foliage re-covers the tire ruts, tire ruts that are created in areas where thermakarst occurs get progressively larger over time and can cause irreparable damage.

Similarly, there are other geographic areas that are ecologically fragile and require protection, such as sand dunes, and beach grass ecosystems. Disruption of the dune based grasses can similarly destroy fragile ecosystems. In order to travel in these remote areas, a vehicle must be able to access such remote areas that frequently lack road, and simultaneously have minimal weight impact to avoid causing beach or dune erosion. Another problem that faces most remote camps is accessibility. Remote camps for industrial uses such as oil fields, research camps, and mining camps have a need for a vehicle that can traverse these areas without causing ecological damage and are not accessible by roads.

Vehicles that are needed to do the work in remote areas must be able to fit into an airplane for transportation to the remote site so that they can be used upon arrival at the site. However, most of the conventional off road vehicles such as ATVs, snow machines, or similar recreational equipment lack the ability to transport large amounts of equipment or to carry more than 2 people at any given time, in any level of comfort.

The Weight Distributed Low Impact Vehicle System has addressed these problems by creating a system that is larger than a conventional remote transportation vehicle, and has the capacity to have a minimal impact on remote ecosystems. Further, it can be shipped to remote locations such as oil rigs by plane such as a Hercules C-130 when the wheels are removed from the vehicle. The wheels can be added to the system, and then the vehicle is fully functioning shortly after off loading it from a plane.

### SUMMARY OF THE INVENTION

The weight distributed low impact vehicle sub frame system (hereinafter known as system) is a means to overcome the problems caused by thermakarst, erosion, and similar ecological damage caused by heavy vehicles in ecologically fragile areas. The system spreads the weight of the vehicle over a larger surface area. This minimizes the impact to a fragile ecosystem, and allows for travel in areas that would otherwise be inaccessible by a vehicle during the summer months. A vehicle equipped with this system is also useful for times such as freezing and thawing, as it allows travel in areas that would otherwise be inaccessible by vehicle.

The system with was designed as a means to allow travel in remote areas, such as the tundra of Alaska or other ecologically fragile areas such as a desert environment with a vehicle without having an adverse impact on the environment. When the system is added to a vehicle, it becomes possible to travel to areas where there is no road access. In remote areas, such as reservations or research camps, this type of vehicle can be modified as an emergency services vehicle, as it has the ability to travel when other modes of transportation such as planes or boats might not be available for emergency services.

The system is designed so that with slight modifications to the upper rail, it can be adapted and used in conjunction with a Chevrolet truck, a Ford, a Dodge van, an automobile, an ambulance, or a flatbed. The development of the man walk about the vehicle allows the driver to access the engine and the back of the vehicle at all times, which would otherwise be inaccessible in field conditions.

### DESCRIPTION OF THE DRAWINGS

FIG. 1 shows a three dimensional picture of the modified sub frame that is attached to the vehicle frame. The front of the vehicle is on the right hand side of the drawing. The wheels and the man walk are attached to the outside of the frame.

FIG. 2 shows a three dimensional picture of the modified sub frame that has the wheels removed, showing the wheel bearing attachments

FIG. 3 shows a three dimensional picture of the modified sub frame without any wheel attachments. The plate attachments that attach the wheels to the bottom of the sub frame.

FIG. 4 shows the rear end of the modified sub frame without the wheels and with part of the man walk surrounding the sub frame

FIG. 5 shows the front end of the sub frame with the man walk where the driver's side is facing the lower left corner of the drawing stripped of tires or wheel attachments. It also shows the transfer case going throughout the sub frame and down into the space under the sub frame.

FIG. 6 shows the isometric sub frame where the driver's side is facing the lower left hand corner. The drawings show the sub frame stripped of the man walk

FIG. 7 shows an isometric version of the sub frame with the passenger side forward. The front of the vehicle is in the lower right corner of the drawing

FIG. 8 shows the front end of the fully equipped system. The tires are attached through plate connections, and the man walk is attached to the outside of the sub frame.

FIG. 9 shows a rear view of the fully equipped system. The tires are attached through plate connection, and the man walk is attached to the outside of the sub frame.

FIG. 10 shows the passenger side view of the sub frame with the wheels attached with the electric steps. (180)

FIG. 11 shows the front bumper and man walk configuration

FIG. 12 shows the placement of the vehicle over the sub frame

### DETAILED DESCRIPTION OF THE DRAWINGS

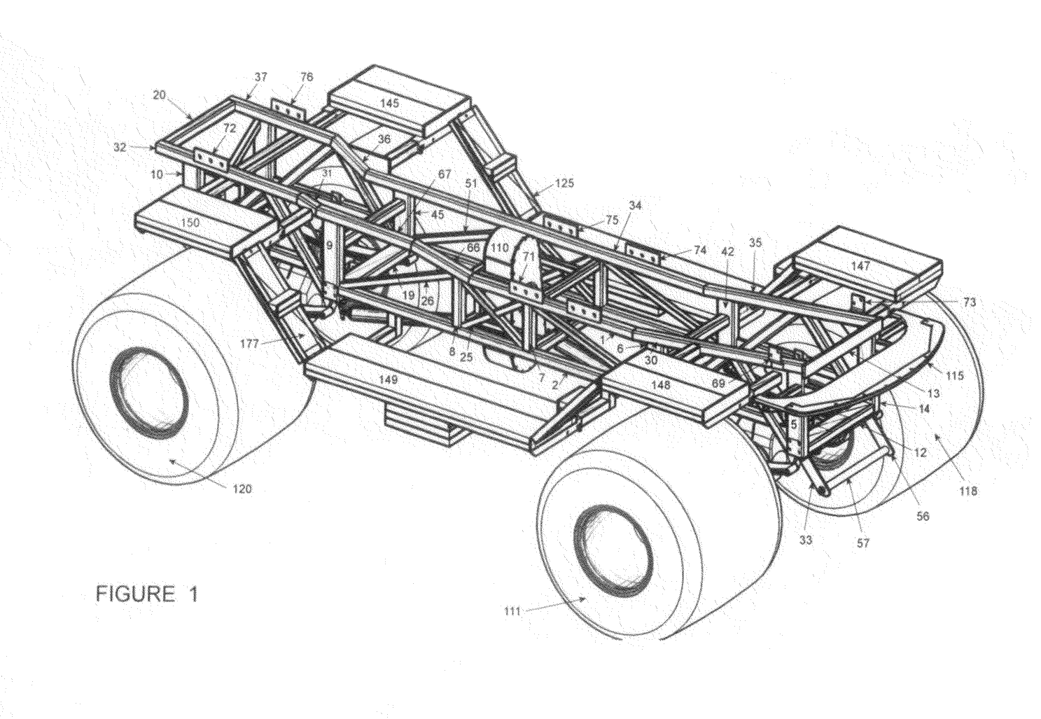

FIG. 1

The vehicle that is pre-purchased is placed on top of the sub frame system. A person would purchase a vehicle, such as a Chevrolet pickup truck, van, or other vehicle of their choice, and the vehicle would be attached to the sub frame system. The system has been modified so that it is powered by the engine of the vehicle that is attached to it.

There are several embodiments. For the purposes of the description, a pickup truck frame is presumed to be on the frame that is utilized for the embodiment in the drawings.

The vehicle frame is bolted onto the sub frame system (and can also be welded onto the sub frame) at multiple points; with the preferred embodiment of at least four points per side at the front of the passenger side (69), the intermediate area before the transfer case (70), directly next to the transfer case (71) and at the rear of the vehicle (72). Similarly, on the driver's side, the vehicle frame is attached to the sub frame at the front of the vehicle (73), at the intermediate part of the vehicle (74), at the transfer case (75), and at the rear of the vehicle (76).

In the preferred embodiment, the top two longitudinal rods are angled upwards both at the front of the rod and at the rear of the rod. In the preferred embodiment, the top rods are pieced together at a slight angle, and then leveled off, as the vehicle is viewed from the center part of the vehicle to the rear of the vehicle. In the preferred embodiment, the rods are all square and hollow rods. Although circular rods can be used instead, square pieces were chosen for their ease of accessibility from the shelf at the supply stores, to avoid the need for retooling, and to minimize manufacturing expenses.

In the preferred embodiment, the lower two longitudinal rods have supplemental attachment rods placed at the front and the rear of the rods. These supplemental front and rear rods that are attached to the lower longitudinal rods are connected to the main two lower longitudinal rods by means of being attached to two horizontal rods. The supplemental longitudinal rods that are attached to the lower longitudinal rods in a slightly higher position so that the supplemental rods form a smaller rectangular box when viewed in comparison to the main rectangular box.

In the preferred embodiment there are six horizontal cross bars that are welded to the top two longitudinal rods, and there are a minimum of six horizontal cross bars that are welded to the bottom of the two longitudinal rods, forming a box structure.

In the preferred embodiment, there are six vertical bars that connect the four longitudinal rods on each lengthwise side of the rectangular box. In the preferred embodiment, there are six bars that are welded in between the short vertical bars at a diagonal to one another that act as additional support for the rectangular box. In the preferred embodiment, the diagonal cross bar that is nearest to the rear of the rectangular box frame is longer than the other diagonal cross bars to compensate for the upward angle of the top two longitudinal bars. In the preferred embodiment, there are two additional bars that cross each other, in the shape of an X and the X is under the driver side and under the passenger side doors. In the preferred embodiment, there is also a series of support bars in the shape of an X that is at the front of the rectangular box under the headlights, and there is also a series of support bars in the shape of an X that is at the rear of the rectangular box under the tail lights. In the preferred embodiment, there is a lateral bar that is placed in front of the X, that is welded to the box so that it crosses the center of the front end of the rectangular box. In the preferred embodiment, the lateral box has two short vertical rods that connect the bottom of the rectangular box to the middle lateral box. This small square is where the winch is located.

In the preferred embodiment, the top longitudinal rods form the corners of a rectangular box, which is connected by a plurality of horizontal rods to the four longitudinal rods. The longitudinal rods are connected by a series of cross bars. The cross bars are supported by several diagonal support bars, which are placed at angles to each other, and which can cross one another. This allows maximum support between the supporting sub frame and the vehicle with minimum weight.

Looking at the modified sub frame from the passenger's side, there is a top modified longitudinal main rod (1), and a lower modified longitudinal main rod (2). On the driver's side, there is a corresponding and parallel top longitudinal main rod (34) and bottom longitudinal main rod (38). These four rods form the fundamental structure, to which everything else is attached.

In the preferred embodiment, the sub frame is created from standard thick walled box tube mild forged steel that is joined together by tig weld. Stick weld, magnetic weld, wire feed, and electric weld, and other welding mediums can be used as well to attach all of the components. In the preferred embodiment, the sub frame consists of four longitudinal rods that are positioned from the front of the vehicle to the rear of the vehicle, although the rectangular box can have more supporting longitudinal rods.

From the passenger's side there is a lower longitudinal supplemental front end bar (3) (positioned under the man walk, but above the tire, 116) that is attached towards the front of the vehicle to the main lower longitudinal rod (2). On the other end of the main longitudinal rod (2) the lower longitudinal supplemental rear bar (4) is welded to the main lower longitudinal rod (2) positioned under the rear man walk, and above the tire, (120).

In the preferred embodiment, there are supportive trusses that are welded below the rectangular box frame directly underneath the passenger cab. In the preferred embodiment, there are a plurality of additional vertical bars that attach the lower longitudinal rods to the upper longitudinal rods.

In the preferred embodiment, the method of welding is stick welding for the sub frame, and butt welding for the attachment pieces, such as for the plates for the man walk. However, other forms of welding can be used as well to attach the subframe together and to attach the subframe to the vehicle.

On the top longitudinal rod (1) there is a top longitudinal supplemental bar at an angle (30) that is attached to the front of the rod, which adds additional length to the longitudinal rod (1). Similarly, at the other end of the longitudinal rod (1), there is a top central longitudinal bar at an angle (66) that attaches to the top longitudinal rod (1). The top central longitudinal bar at an angle (66) is then attached at the end of it to the top central longitudinal parallel bar (67), which is attached to the rear intermediate supplemental rod (31) that is attached at an angle to the rear top longitudinal bar attached at an angle (32) This whole rod forms the elongated portion of the top bar for the frame.

At the front of the sub frame on the passenger's side the front vertical support (5) attaches to the lower longitudinal supplemental front end bar (3) and to the front supplemental longitudinal bar that is attached at an angle (30). The next vertical support on the passenger's side that connects the top and bottom longitudinal rods together is the front midsection vertical large support (6) that attaches between rods (2) and (1). Near the transfer case (110), the intermediate forward vertical central support bar (7) connects the top longitudinal rod (1) and the lower longitudinal rod (2) together. The aft intermediate vertical central support bar (8) connects the top longitudinal rod (1) with the lower longitudinal rod (2). The rear midsection large vertical support (9) connects the end of the top longitudinal rod (1) with the lower longitudinal rod (2). The rear vertical support (10) is the final vertical support on the passenger side that connects the supplemental top rear passenger rod (32) to the lower supplemental longitudinal rod (4).

In the preferred embodiment the springs attach to the box sub frame, which attach to shackles that have upper and lower fittings that are placed around an industrial quality axle that allows both front and rear steering.

The industrial size front tire on the passenger side (111) is attached to a commercial industrial axle (116), which is also attached to a driver's side industrial tire (118). Similarly the driver's side tire (119) is attached to the industrial axle (117) which is attached to the passenger side industrial tire (120).

For remote tundra or sand access, the preferred tires are sixty six inch tires. The system is able to use a variety of different tires, and the type of tires determines the use of the vehicle usage. For example, a tundra floatation tire would be used for driving the vehicle system across tundra. A V bar tread tire would be a better use for search and rescue operations. A terragrip tire would be preferable for enhanced traction for off road recreational use. For the purposes of transporting the vehicle system to a remote location the preferred method is to put the vehicle system on thirty one (31) inch tires so that it can fit into the body of the airplane for transport, and then bringing larger tires for minimal ecological impact.

The system can have multiple features added to it beyond the basic design. Depending upon the work application, the system can have additional work lights, auxiliary lights, multiple winches, tow loops, an auxiliary fuel tank, auxiliary batteries, GPS for remote location directions, emergency medical services, spare tires, outside tool kits, additional retractable mounting systems to walk on and around the vehicle, and additional forward and backup cameras.

The preferred embodiment has a traction bar attached to it to avoid rolling. The preferred embodiment is equipped with arctic lubricants and arctic grade seals used in the vehicle to avoid freeze up. The system can also be useful in desert areas, and be equipped with higher temperature lubricants and seals to offset the effects of the heat on the system and all of its component parts.

The system is designed to be built from parts that can be easily picked up at material shops, thereby avoiding problems with ordering and waiting for custom parts, and costly delays in remote areas.

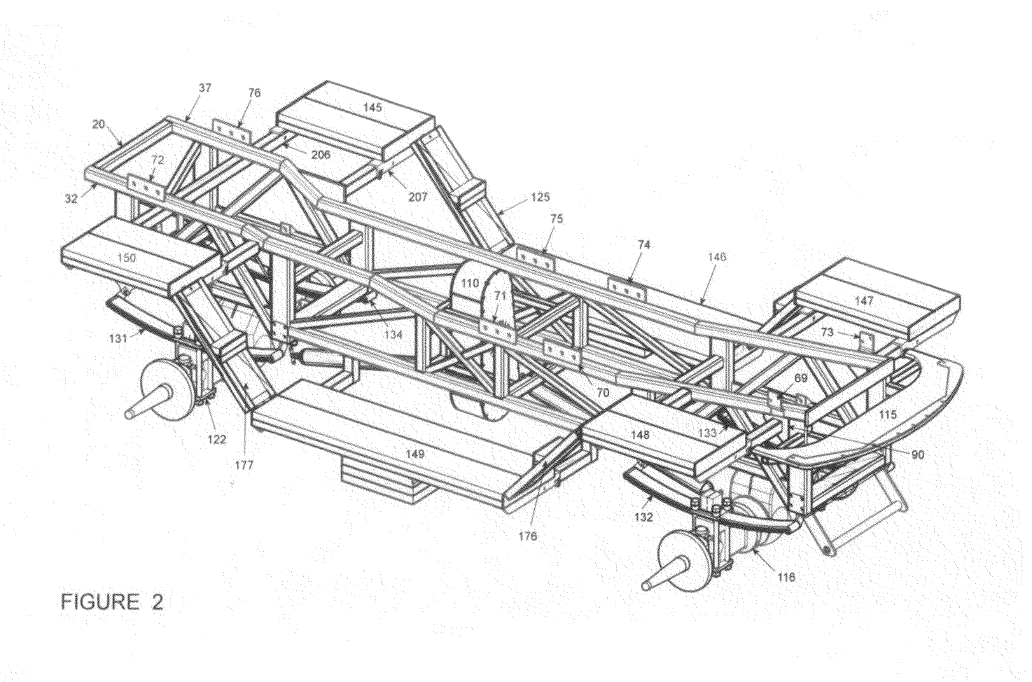

FIG. 2

In the preferred embodiment, there are two rods that are attached on each side of the rectangular box at the front of the frame onto the traction rod that form a triangle on each side of the traction bar. These are the supports for the man walk (115).

The front man walk (115) is positioned before the front of the car, on the top of the sub frame attached to the tops of driver's side man walk support (61), the front hypotenuse rod (62) and the driver's side front top equidistant rod (63). On the passenger side, the front man walk (115) is attached to front vertical rod (5). The passenger's side man walk support (58) is attached to the front hypotenuse rod (59), which is in turn attached to the front top equidistant rod (60), forming a triangle that is attached to the front vertical rod on the passenger's side (5). The front man walk (115) allows a person to walk around the front of the vehicle and repair the engine if necessary.

The man walk on the vehicle. (145) (125) (126) and (147) (178) are on the driver side, and (148), (149), (77) (177) (176) and (124) are on the passenger side. There is an additional man walk that is positioned on top of the platform in the front of the truck.

In the preferred embodiment, the man walks are made out of metal grids or other slip resistant materials so that the driver or the passengers can easily get in and out of the vehicle without slipping on the ice in Arctic conditions, or avoid risk of slipping or falling in swamp or desert conditions, depending on where the system is utilized. Plastic grids can also be used, or any other non slip material. A protective rail can also be added around the man walks for passenger and driver safety, should there be a need for additional safety precautions.

The figure shows a side view of the vehicle with the tires removed. The rear axle (117) is attached by the block coupling mechanism (122), which is attached to the travel stop (131).

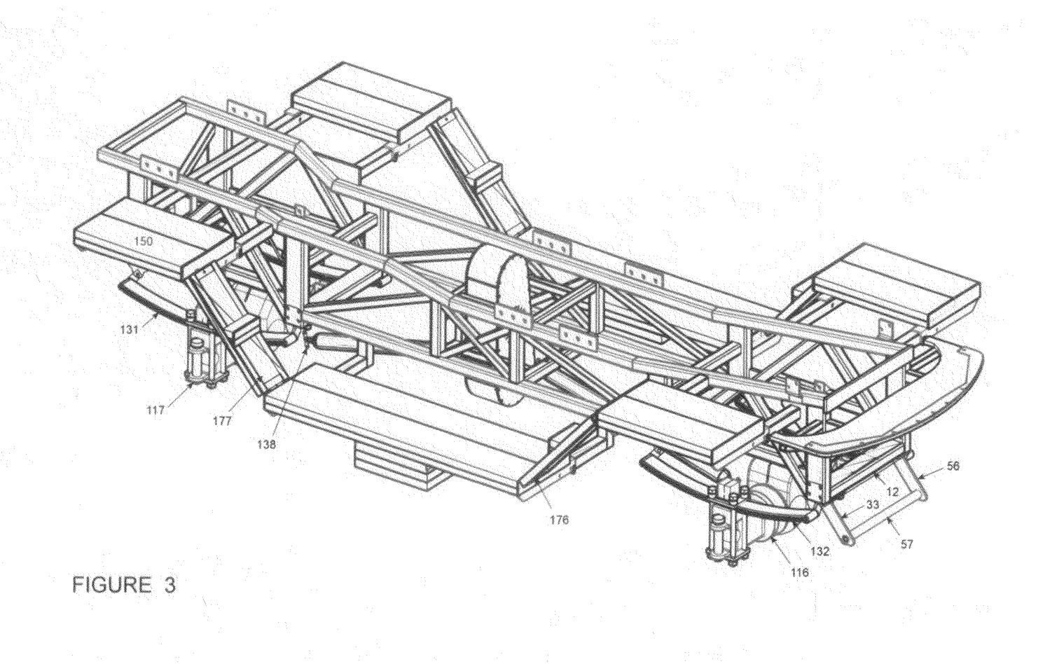

FIG. 3

There is a brush guard passenger side extension rod (33) that extends out in front of the passenger side. At the bottom of the brush guard (33) there is a brush protective rod (57) that is connected on the driver's side to another brush guard extension (56). The lower driver's side brush bar (56) is connected to the lower front horizontal bar (12). The horizontal brush bar (57) is positioned between the driver's side brush bar (56) and the passenger's side brush bar (33).

The rear axle (117) is attached to a block coupling mechanism (122 on the rear passenger side) and 124 that attaches to the rubber travel stop (131). There are stops for each wheel well. The stops are also attached to the lower part of the sub frame (112) FIG. 3 also shows the spring system (138) that is used to attach the brakes to the travel stop (131) on the rear tire. The spring system is prevalent on all four wheels.

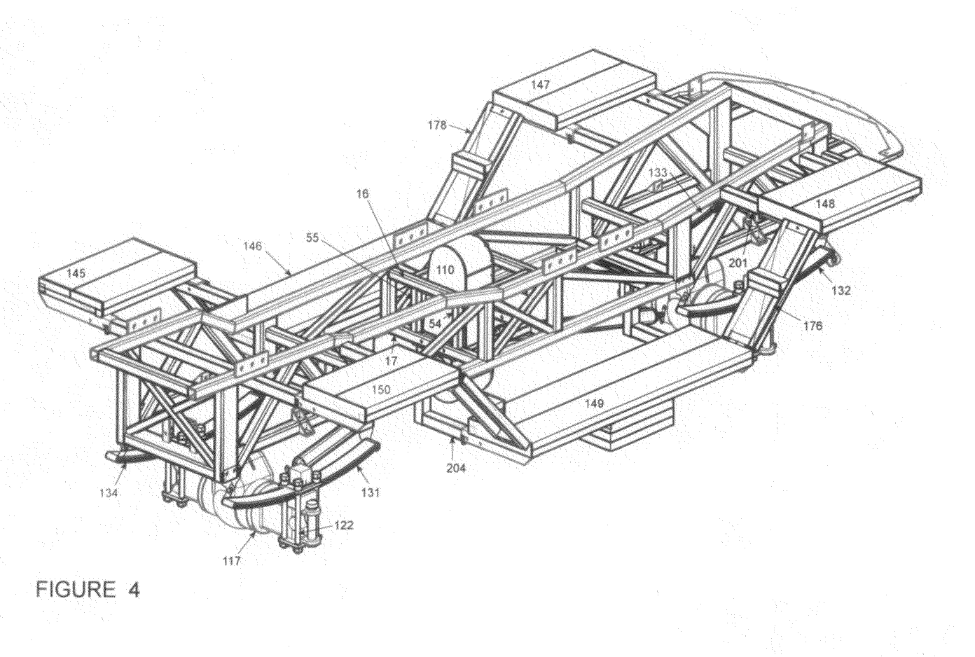

FIG. 4

The driver's side central vertical bar (54) supports the transfer case (110) and connects (16) to (17). Similarly, the passenger's side central vertical bar (55) supports the transfer case (110) and connects (16) to (17).

The spring and plate arrangement attaching the rear axle (117) to the wheels is delineated. The rear passenger side flexible travel stop (131) is attached to the axle by an upper and lower plate system (122).

The industrial axles (116 and 117) are attached to the springs (122, 123, 124, 125) that are located above each wheel. The axle attaches to a coupling mechanism (121). There are four coupling mechanisms: one for each wheel. The coupling mechanism (121) holds the axle in the bottom of the coupling mechanism, and holds a spring (122) in the top of the coupling mechanism. There is one spring for each tire, and two springs and coupling mechanisms are attached to each axle (thus, the spring and coupling mechanism that is hard to see on the driver's side would be 127 and 128, 129, and 130). The spring is fastened on to the sub frame at the end of the frame (21).

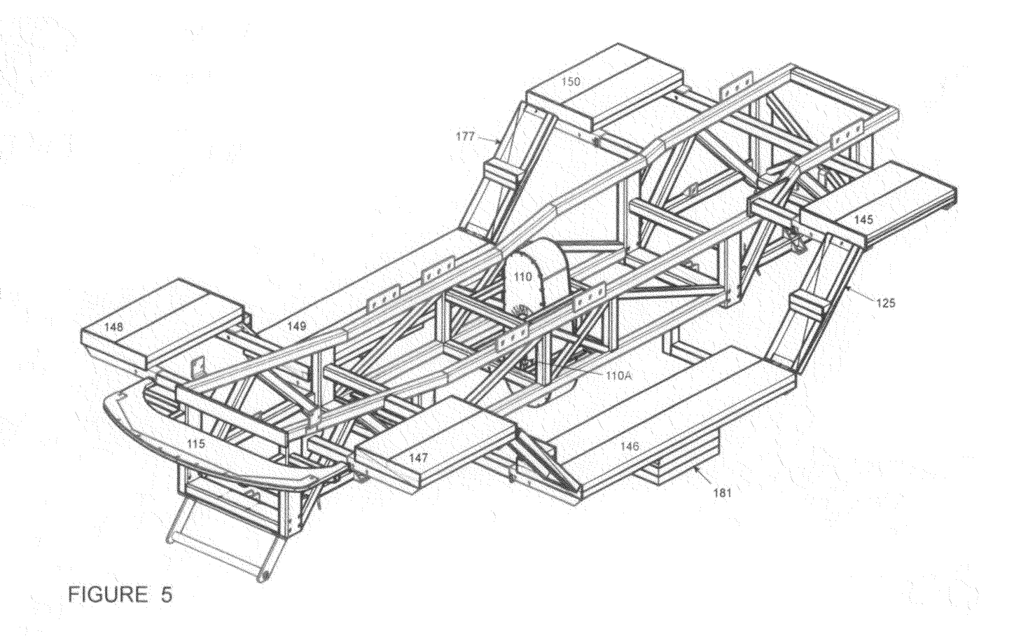

FIG. 5

FIG. 5 shows the man walk on the driver's side (126).

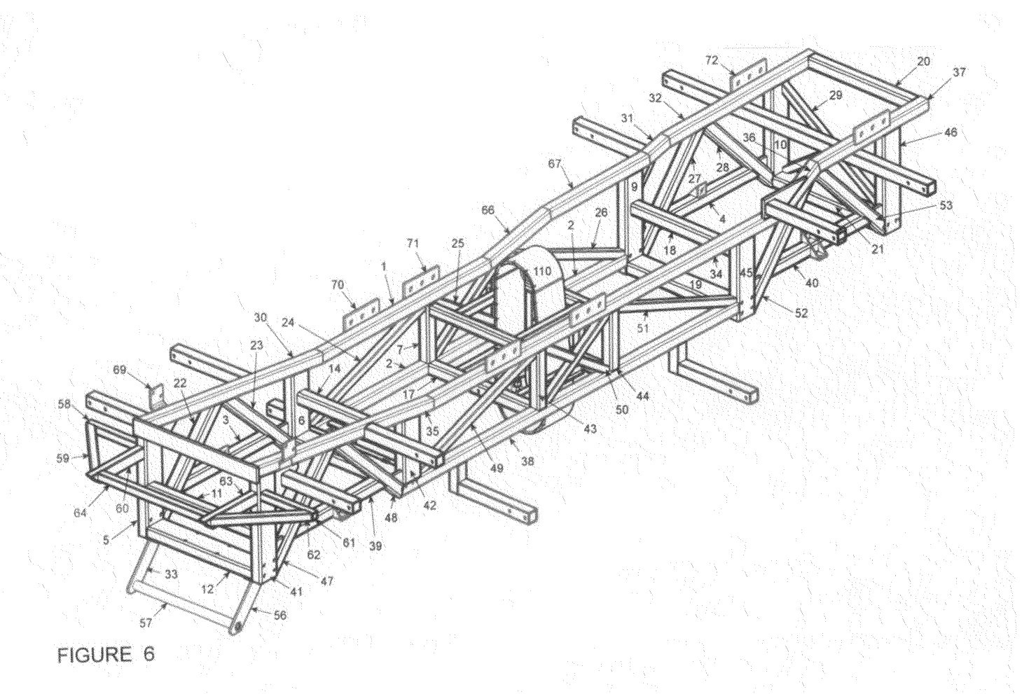

FIG. 6

The front horizontal small cross member on the passenger's side (11) connects the vertical rod (5) to the sub frame to the driver's side vertical bar (41). The large lower front horizontal cross bar (12) connects the front vertical rod on the passenger's side (5) to the driver's side front vertical bar (41). The top front horizontal cross bar (13) also connects the front vertical rod on the passenger's side (5) to the driver's side front vertical rod (41). All three of the horizontal support bars (11, 12, and 13) connect to bars (5) and (41), forming a bifurcated square These bars (5, and 41) connect to the lower supplemental rods on the passenger's side (3) and the lower supplemental rod on the driver's side (39), as well as to the top front supplemental rod on the passenger's side that is at an angle (30) and to the top supplemental bar (35). The lower supplemental rod (3) attaches to (6), which connects to (30) on the passenger side, as well as attaches (6) to (1) and (2).

The intermediate top forward cross member (14) connects the front midsection vertical large support on the passenger side (6) to the driver's side front midsection vertical large support (42). The intermediate bottom forward cross member (65) connects the front midsection vertical large support on the passenger side (6) to the driver's side front midsection vertical large support (42). The four pieces are welded together and form a square, and provide additional support to the structure.

The midsection vertical large supports (6) and (42) are attached on top of the lower longitudinal rods (2) and (38) and the lower supplemental rods (3) and (39) are attached to the side of the midsection vertical large supports (6) and (42), providing additional strength to the frame.

The bottom central horizontal cross bar (15) connects the lower longitudinal main bar on the passenger's side (2) with the lower longitudinal main bar on the driver's side (38).

The aft top central horizontal cross bar (16) connects the top longitudinal main rod on the passenger's side (1) to the top longitudinal main rod on the driver's side. (34). The aft bottom central horizontal cross bar (17) connects the bottom longitudinal main rod on the passenger's side (2) to the bottom longitudinal main rod on the driver's side (38).

There is a similar arrangement on the other side of the sub frame. On the driver's side, the lower supplemental bar (39) attaches to the front midsection vertical support (42) which is also where the lower driver longitudinal rod (38) connects to the upper longitudinal rod (34). In the preferred embodiment, the front supplemental longitudinal rod (39) is connected to the side of the front midsection vertical support (42). The front midsection vertical support (42) is attached on the top of the lower longitudinal rod (38).

The rear intermediate horizontal cross bar (18) connects the rear midsection large bar vertical support on the passenger's side (9) to the rear midsection large bar vertical support on the driver's side (45). Similarly the lower intermediate large horizontal bar (19) connects (9) to (45). The vertical support on the passenger's side (9) is attached to (67), and joins (27) to (2).

The rear top horizontal cross bar (20) connects the passenger's side rear top supplemental bar attached at an angle (32) to the driver's side rear top supplemental bar attached at an angle (37), as well as to connect the rear vertical support on the passenger's side (10) to the rear vertical support on the driver's side (46).

The rear lower horizontal cross bar (21) connects the passenger side rear supplemental lower bar (4) to the driver's side rear supplemental lower rod (40), as well as to connect the rear vertical support on the passenger's side (10) to the rear vertical support on the driver's side (46)

The forward primary diagonal cross bar (22) connects the lower supplemental front longitudinal rod (3) on the passenger's side to the upper supplemental front longitudinal rod (30). The forward secondary cross bar (23) connects the same rods (30) and (3) together.

The forward intermediate diagonal cross bar (24) connects the primary top longitudinal rod on the passenger's side (1) and the primary bottom longitudinal rod on the passenger's side (2). The central support cross (25) surrounds the transfer case (110) on the passenger's side. The central support cross (25) connects the primary top longitudinal rod (1) to the primary bottom longitudinal rod (2) on the passenger's side, and is placed between the vertical central support bar (7), and the aft intermediate vertical central support bar (8).

The central diagonal support cross bar (26) connects the top main longitudinal rods (1) and (67) to the bottom main longitudinal rod (2). The rear primary diagonal cross bar (27) connects the lower rear supplemental longitudinal rod (4) to the top supplemental rear longitudinal rod at an angle (32). The rear secondary diagonal cross bar (28) connects the lower rear supplemental rod (4) to the top supplemental rear longitudinal rod at an angle (32).

The rear diagonal X (29) connects the rear lower horizontal cross bar (21), the rear vertical support on the passenger's side (10) and the rear midsection large bar vertical support on the driver's side (46), resulting in additional support to the rear.

On the driver's side, there is a rear intermediate supplemental longitudinal rod (36) that is joined between the rear supplemental longitudinal rod at an angle (37) and the driver's top longitudinal rod (34). There is a front top supplemental rod on the driver's side (35) that is attached to the top longitudinal rod (34).

The front central vertical support on the driver's side (43) is connected to the driver's side top longitudinal rod (34) and to the bottom driver's side longitudinal rod (38). The aft central vertical support on the driver's side (44) is connected to the driver's side top longitudinal rod (34) and to the bottom driver's side longitudinal rod (38). The aft central vertical support (44) forms a box by virtue of being connected to (16), (17), and (8).

The intermediate rear vertical support (45) is joined between the top longitudinal rod on the driver's side (34) and connects to the bottom longitudinal rod on the driver's side (38). The intermediate rear vertical support (45) forms a box with (18), (19) and (9).

The aft intermediate diagonal cross bar (51) connects the primary top longitudinal rod (34) to the bottom longitudinal rod (38) on the driver's side. The rear primary diagonal cross bar (52) connects the rear intermediate supplemental longitudinal rod on the driver's side (36) and the bottom rear supplemental longitudinal rod on the driver's side (40). The rear secondary diagonal cross bar (53) connects the rear intermediate supplemental longitudinal rod on the driver's side (36) and the bottom rear supplemental longitudinal rod on the driver's side (40).

The front intermediate diagonal cross bar (49) is attached to the driver's side lower longitudinal bar (38) and the driver's side upper longitudinal bar (34). The central support cross on the driver's side (50) surrounds the transfer case (110) on the driver's side. The central support cross (50) connects the primary top longitudinal rod (34) to the primary bottom longitudinal rod (38) on the driver's side, and is placed between the vertical central support bar (43), and the aft intermediate vertical central support bar (44).

The front primary diagonal cross bar on the driver's side (47) is connected to the driver's side top longitudinal supplemental bar at an angle (35) and the driver's side lower longitudinal front supplemental bar (39). The front secondary diagonal cross bar on the driver's side (48) is connected between the driver's side top longitudinal supplemental bar at an angle (35) and the driver's side lower longitudinal front supplemental bar (39).

On the driver's side, the driver's side man walk support (61) is attached to the drivers side front vertical rod (41). The driver's side man walk support (61) is attached to the front hypotenuse rod (62) which is attached to the driver's side front top equidistant rod (63). Forming a triangle that is attached to the front vertical rod on the drivers side (41). The front extruding support bar (64) is attached to the passenger side front top equidistant rod (60) and the driver side front top equidistant rod (63).

The passenger's side man walk support (58) is attached to the passenger's side front vertical rod (5). The passenger's side man walk support (58) is attached to the front hypotenuse rod (59), which is in turn attached to the front top equidistant rod (60), forming a triangle that is attached to the front vertical rod on the passenger's side (5).

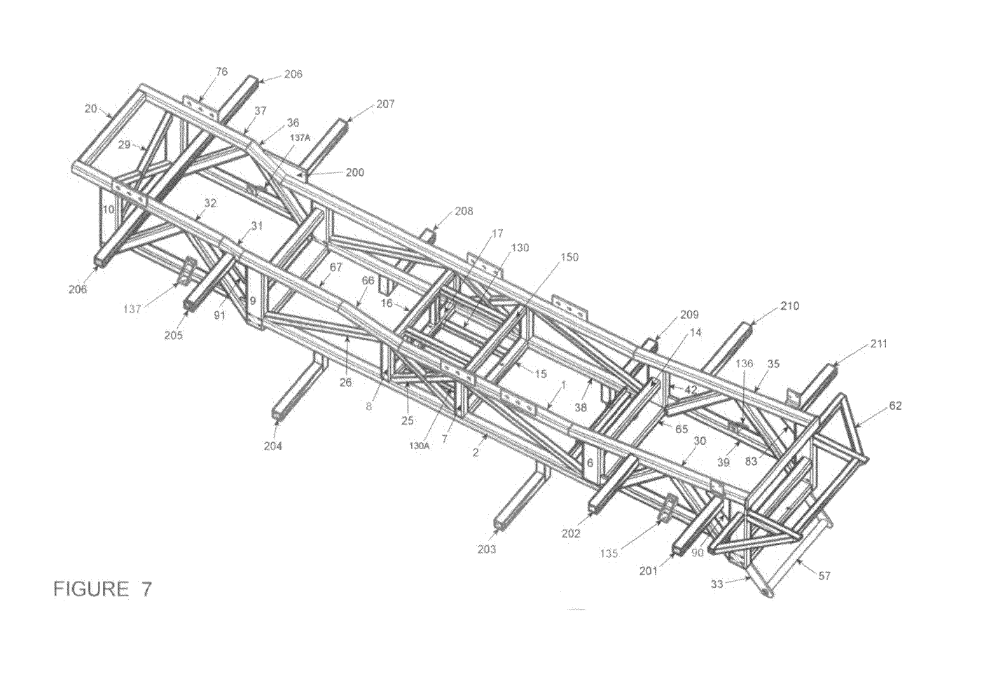

FIG. 7

FIG. 7 illustrates the additional supports for the transfer case. Underneath the space where the transfer case resides, there are two supportive bars (130) and (131) which are attached to both the aft bottom central horizontal cross bar (17) and the fore bottom central horizontal cross bar (15).

The passenger side transfer case support (130) is attached halfway between bars (15) and (17) as is the driver side transfer case (131). There is also cross bar (150) that is placed directly above (15) and is attached to the longitudinal rods (1) and (34) so that a box is formed.

FIG. 7 also illustrates the supportive braces that go under the man walk, so that the man walk has adequate structural support and can hold the weight of one or more people walking around the vehicle. The front passenger manwalk (201) is attached to the supplemental front longitudinal rod at an angle (30). It is attached to the metal plate (90) that is welded to (30) and to (5). (202) is attached directly to the longitudinal rod (30).

The lower man walk supplemental braces on the passenger side (203 and 204) are attached to the lower longitudinal rod (2). The rear primary man walk support on the passenger's side (205) is attached to the rear intermediate supplemental rod (31). The rear primary rear passenger man walk support (205) is attached to the plate (91) that is attached to (31), (67) and (9).

There is a manwalk bracing rod (206) that is attached at the end to both upper longitudinal rods (32) and (37). There is a supplemental manwalk brace (207) that is attached to the upper longitudinal rods (36 and 34) via a metal support flange (201).

The lower man walk supplemental braces on the driver's side (208 and 209) are attached to the lower longitudinal rod (38). The front driver's manwalk support braces (210 and 211) are attached to the top supplemental bar (35). On the driver's side the front primary driver man walk support (211) is mounted to the metal plate (83) which is welded to (35) and to (41).

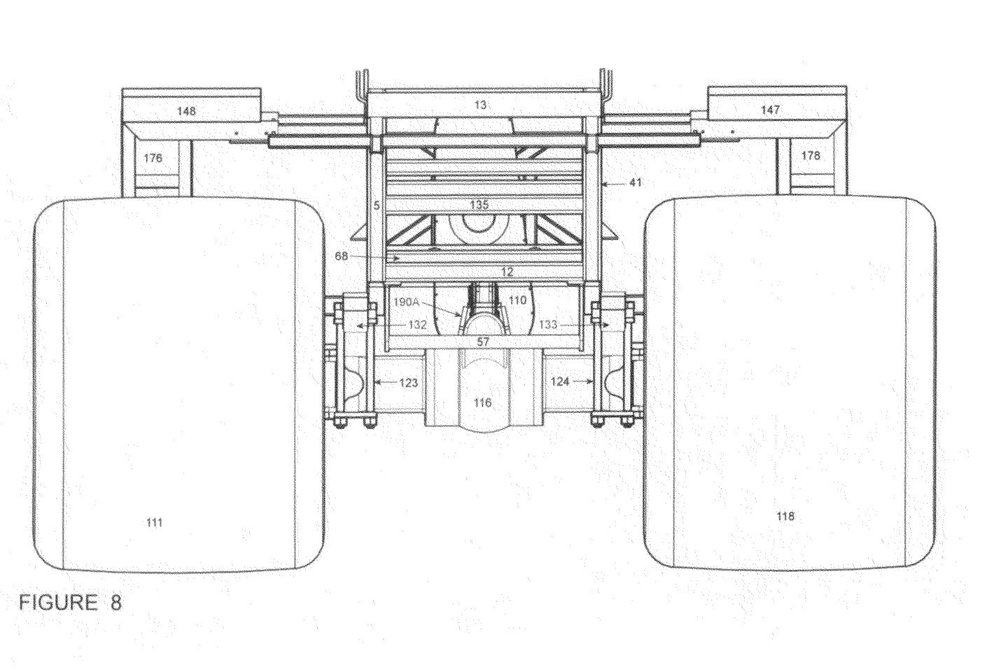

FIG. 8

This is a front end view of the vehicle. The front end wheels (111) and (118) are attached to the front axle (116). The plate connecters (123) and (124) are attached to the axle (116).

There is a removable drip pan (68) that fits on the top of the lower longitudinal rods (3) and (39) that is used to catch the fluids under the vehicle. In the preferred embodiment, the drip pan is disposable. The pan also serves to minimize ecological impact in ecologically fragile areas, should a leak in the vehicle engine occur. The front passenger bumper mount (135) is attached to (3) and (39). The driver front bumper mount (136) is attached to the driver supplemental bottom longitudinal rod (39). The passenger back bumper (137) is attached to the passenger side bottom supplemental rear longitudinal rod (4) and the driver rear bumper mount (128) is attached to the driver rear supplemental longitudinal rod (40).

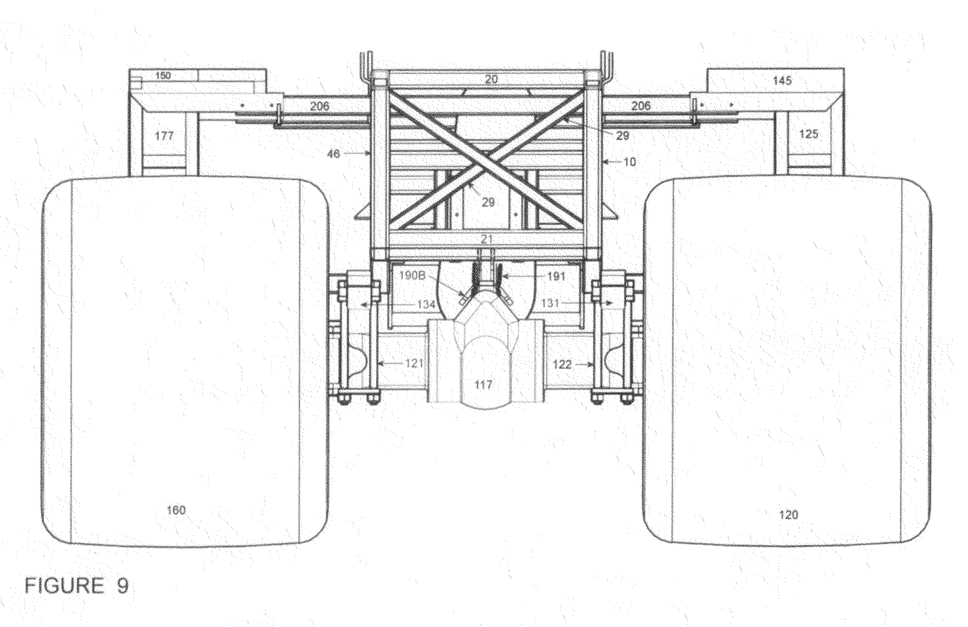

FIG. 9

This is a rear view of the system. The connecting Y (190) shows an additional connection between the industrial axle and the sub frame, giving it additional support. The solanoids that connect to the industrial axles are shown next to (191). In the preferred embodiment, there are solanoids on the front of the transfer case and the rear of the transfer case. There are also springs attaching the subframe to wheel axles for additional flexibility.

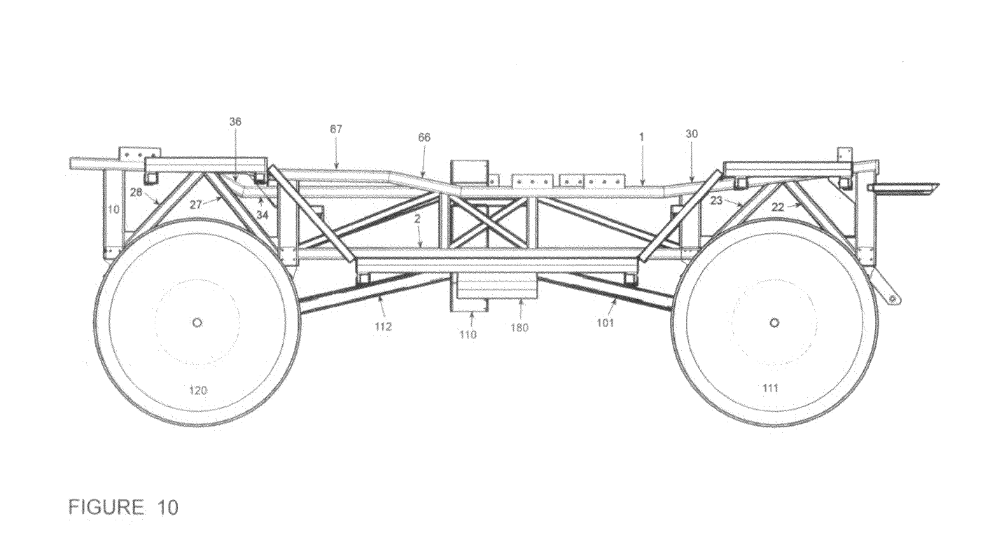

FIG. 10

The transfer case (110) is attached to a front parking brake line (101) and to the rear parking brake line (112). The parking brake line (101) attaches to the front independent industrial axle (113) and the rear parking brake line (112) attaches to the rear independent industrial axle (114). The transfer case is also where the U joint (90) from the transfer case drops to the differential via the drive line.

The removable ladder (180) and (181) are positioned next to the manwalk on both sides. In the preferred embodiment, the removable ladder is an electric ladder such as one that is found on a motorhome. The removable ladders can be on each side of the man walks, one for the driver, one for the passenger.

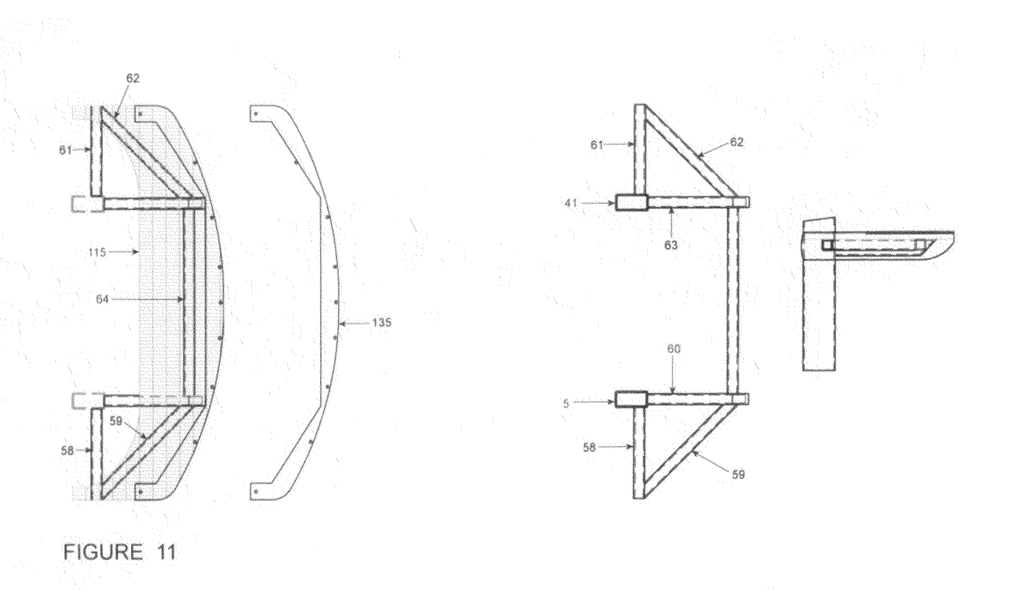

FIG. 11

This figure shows the placement of the front bumper in front of the man walk

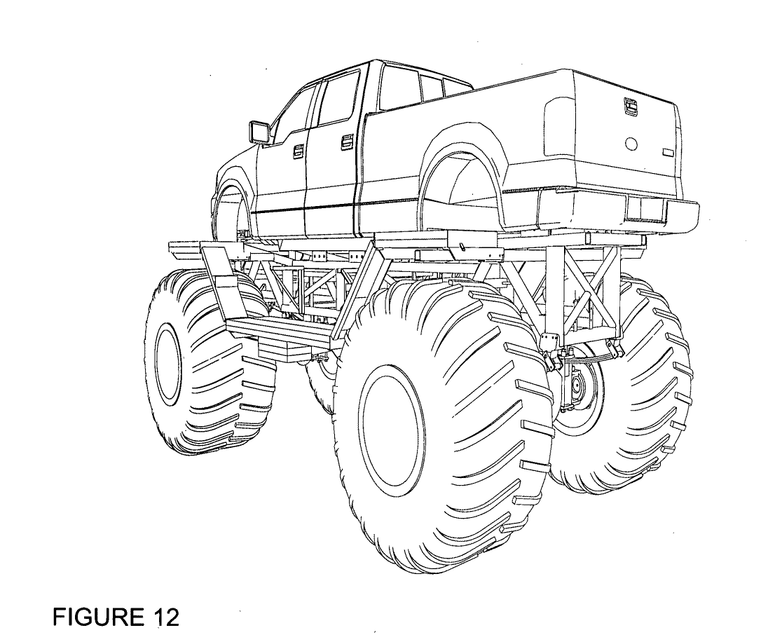

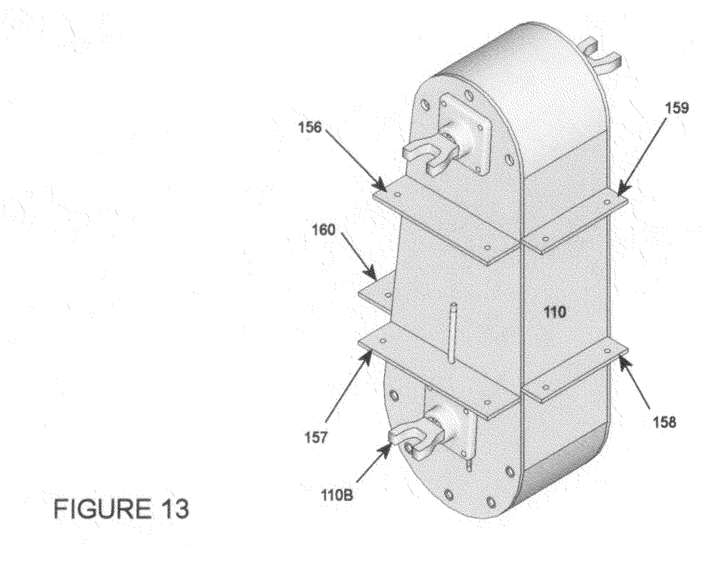

FIG. 12

This figure shows how the vehicle is placed on the top of the sub frame and all of its components

I claim the following:

1. A weight distributing transportation system comprising: a vehicle body connected to a modified hollow rectangular box sub frame so that the sub frame is positioned below the vehicle,
at least two heavy duty axles that have independent steering capacity, four wheel drive ability,
low impact rotation tires,
a traction bar,
a modified transfer case that can accommodate a raised vehicle,
a self centering device,
multiple attachment points whereby the vehicle is attached to the system, passenger access means (otherwise known as a man walk)
a man walk that traverses around the majority of the vehicle, and

2. The claim of claim 1, wherein said rectangular box sub frame comprising at least four modified longitudinal rods that are positioned from the front of the vehicle to the rear of the vehicle forming a box;
said modified longitudinal rods are connected to each other by a plurality of horizontal and vertical bars that are attached by a securing means, and
said modified longitudinal rods have additional smaller supplemental rods attached to the modified rectangular box thereby extending the length of the box at an multiple angles, and
both the modified longitudinal bars and the supplemental longitudinal bars are joined to and supported by a plurality of cross bars attached to them, and the cross bars are joined to and supported by a plurality of support bars that are aligned in a diagonal fashion, supporting the sub frame and the vehicle, and

2. The claim in claim 1, wherein said axles are coupled to the sub frame by means of utilizing a coupling mechanism consisting of a top plate and bottom plate that attach to the axle, and
the axles are attached to a spring system, which is in turn attached to the parking brakes, which is in turn attached to the transfer case, and
said axles are attached to a spring system so that the vehicle has suspension capabilities, and

3. The claim of claim 1, wherein the sub frame is attached to at least two axles that have the capacity to be steered independently of one another, and

4. The claim of claim 1, wherein the axles are connected to at least two sets of large industrial tires per axle, and
said tires are in a range from 25 inch rims to 66 inch rim tires, and

5. The claim in claim 1, wherein said self centering device comprises electronic sensors that are hooked to a pump which enables the vehicle to steer by use of a toggle switch in the cab of the vehicle, and

6. The claim of claim 1, wherein the sub frame system is composed of hollow rods, and

7. The claim of claim 1 wherein the attaching means to attach the subframe to the vehicle is by welding, selected from the group butt welding, magnetic pulse welding, tig welding, and stick welding, and

8. The claim in claim 1 wherein there are at least four attachment points per side of the system to the vehicle to secure the vehicle to the system, and

9. The claim of claim 1, wherein the sub frame attachment method is selected from the group consisting of bolting, welding, and both bolting and welding, and

10. The claim of claim 1 wherein the man walk comprises a series of supports that are attached to the subframe by an attaching means, and are surrounding the sub frame.

11. A kit comprising the modified hollow rectangular subframe of claim 1, with prefabricated attaching means to attach the subframe to a vehicle, a transfer case, front and rear axles, and four tires, to be attached to a new vehicle that are pre-built.
The term “about” and “approximately” as used herein may be applied to modify any quantitative representation which could permissibly vary without resulting in a change in the basic function to which it is related. For example, the retaining system as described herein can be suspended not only over a horizontal bar, but can be used as a weighted system by placing the heavier counterweight on a flat surface and allowing the suspending compartment and the other compartments to hang from the side of the flat surface.
The present disclosure should not be construed in any limited sense other than that limited by the scope of the claims having regard to the teachings herein and the prior art being apparent with the preferred form of the system disclosed herein and which reveals details of structure of a preferred form necessary for a better understanding of the system and may be subject to change by a skilled person within the scope of the art without departing from the concept thereof.
